(19) United States
(12) Patent Application Publication
(10) Pub. No.: US 2008/0026860 A1
(43) Pub. Date: Jan. 31, 2008

(54) Billiard cue for reducing cue ball deflection

(75) Inventors: Stephen Titus, Daytona Beach, FL (US); Thomas J. Black JR., Merrimack, NH (US); Allan G. McCarty, Jacksonville, FL (US); Paul Costain, Lakeland, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Clawson Custom Cues, Inc. d/b/a Predator Products, Jacksonville, FL (US)

(21) Appl. No.: 11/607,453

(22) Filed: Dec. 1, 2006

Related U.S. Application Data
(63) Continuation of application No. 11/429,915, filed on May 8, 2006, now abandoned.
(60) Provisional application No. 60/680,272, filed on May 12, 2005.

(51) Int. Cl. A63D 15/08; C01B 35/00

(52) U.S. Cl. 473/44; 264/129; 423/276; 473/1

(57) ABSTRACT

Cue sticks, shaft sections of cue sticks, and methods of using such devices are disclosed, where the devices are configured to reduce the phenomenon of cue ball deflection. In particular, limits upon the mass of the cue stick in a section extending from the tip to a predetermined distance toward the butt end are revealed to improve cue ball deflection characteristics. Other embodiments of the invention place a lower limit on the bending stiffness of the tip end of a cue stick or shaft to reduce accentuation of cue ball deflection under high offset/high velocity conditions. As well, an upper limit on specific section modulus is described for deterring the phenomenon of double strike in off center ball strikes.

### RELATED APPLICATION

This application is a continuation of U.S. application Ser. No. 11/429,915, filed May 8, 2006, which claims the benefit of U.S. Provisional Application No. 60/680,272, filed on May 12, 2005. The entire teachings of the above applications are incorporated herein by reference.

### BACKGROUND OF THE INVENTION

Players of pool and other billiard type games shoot a billiard ball with a cue stick to impart a desired motion to the struck ball. Striking a ball along a line that does not pass through the center of mass of the ball imparts english, spin, draw or follow, to the ball. Such a ball strike, herein an off center shot, causes the ball to travel in a manner that may be particularly advantageous during a billiards game. Off center shots, however, can also cause the struck cue ball to follow an initial trajectory that is not parallel to the line of stroke of the cue stick. This phenomenon, known as cue ball deflection, causes the ball to travel at an angle relative to the stroke line. Cue ball deflection is influenced by the speed of the cue striking the ball, the amount by which the line of stroke deviates from the location of the center of mass of the struck ball, and the characteristics of the cue stick. Players imparting english to their shots can have a difficult time adjusting their play to account for cue ball deflection.

U.S. Pat. Nos. 6,110,051 and 6,162,128 describe billiard cues that decrease cue ball deflection. Some cue sticks are described as having shafts with bores that lighten the cues, making outward flexing of the tip end of the shaft easier upon striking a ball. The easier outward flexing, in turn, decreases cue ball deflection. It is also recognized that having the cue stick constructed of a material having a high modulus of elasticity can be advantageous.

### SUMMARY OF THE INVENTION

A cue's ability to decrease cue ball deflection is a functional blend of both the configuration of the shaft of the cue and the material properties of the parts of a cue that make up the shaft. That is, a cue stick will not necessarily have favorable cue ball deflection properties if the stick has a hollow shaft, or if the stick's shaft is made of a high modulus material. Testing and experimental development of cue sticks, and in particular the shaft or tip end of cue sticks, has led to the identification of quantitative measures of mass, mass distribution, and stiffness in cues that provide for enhanced reduction in cue ball deflection relative to existing pool cue stick design. Thus, a potential advantage of the present invention is providing guidance in constructing cue sticks tailored to various types of billiard or pool games to reduce cue ball deflection. With the use of composite materials, such as carbon fiber/epoxy or a blend of composite and wood, cue stick manufacturers can tailor a cue stick to have a certain playing property if the necessary quantitative parameters of the cue stick properties are known.

One embodiment of the invention is directed to a cue stick. The cue stick includes a section extending from the tip toward the back end of the stick for about 3 inches. The section has a mass of less than about 5.1 grams. The cue stick may also include a second section, including the first section, extending from the tip toward the back end of the stick for at least about 4 inches. The second section has a bending stiffness greater than about 3600 lb_{f} in², more preferably greater than 4300 lb_{f} in² for pool games, and more preferably greater than 5600 lb_{f} in² for carom, averaged over the length of the second section. Alternatively, the cue stick includes a shaft having a bending stiffness greater than about 3600 lb_{f} in², more preferably greater than about 4300 lb_{f} in² for pool games, and more preferably greater than about 5600 lb_{f} in² for carom, averaged over a length of at least about 4 inches of the shaft, from the tip end of the shaft toward the butt end. In another alternative, the cue stick includes a shaft having a specific section modulus less than about 10000 lb_{f} in³/g averaged over a length of at least about 4 inches of the shaft, from the tip end of the shaft toward the butt end.

Other embodiments of the invention are directed to a cue stick with a section extending from the tip of the stick toward the butt end of the stick. The section has a length of about 2 inches and a mass less than about 3.7 grams; or a length of about 1 inch and a mass less than about 2.3 grams.

In another embodiment, a cue stick comprises a shaft having a predetermined bending stiffness at a node of the cue stick, the predetermined bending stiffness being lower than a bending stiffness at positions adjacent to the node of the cue stick.

In another embodiment, a cue stick comprises a shaft having a node, and the composition of the shaft at or proximal to the node is different from the composition of the shaft over the remainder of the shaft in order to “fine tune” the performance of the cue.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side view of a cue stick, consistent with an embodiment of the invention.

FIG. 2A is a cross sectional side view of the tip end of a cue stick having a bore in the shaft, consistent with an embodiment of the invention.

FIG. 2B is a cross sectional side view of the tip end of a cue stick having a solid shaft, consistent with an embodiment of the invention.

FIG. 3 a photograph of the robotic arm used to conduct experimental testing of cue ball deflection.

### DETAILED DESCRIPTION OF THE INVENTION

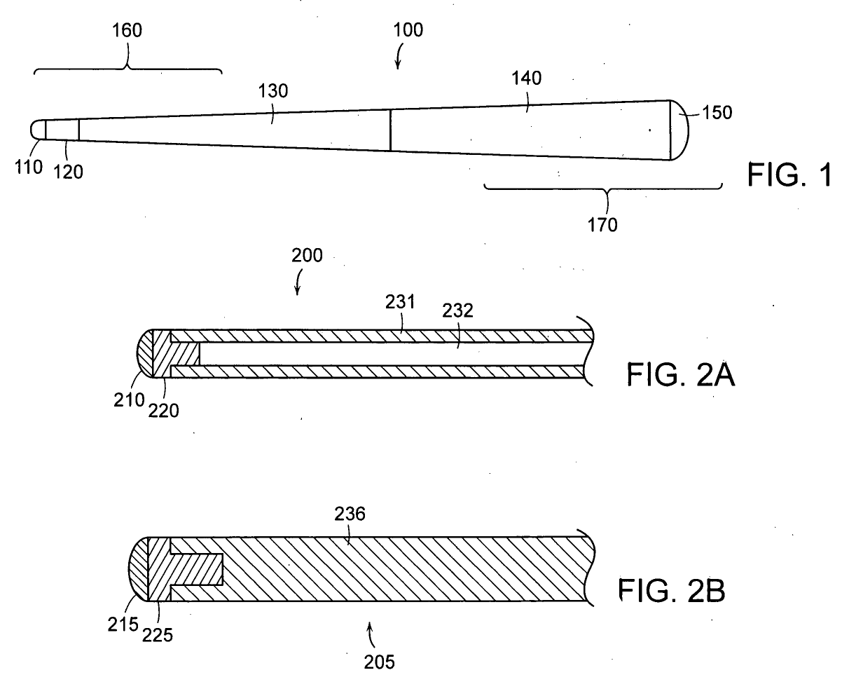

Some embodiments of the invention are directed to a cue stick as depicted in FIG. 1. The cue stick 100 comprises a tip 110 for striking a cue ball, a shaft 130, and a handle section 140. The stick may include a butt 150, to cap the butt-end 170 of the stick 100 and handle section 140. A ferrule 120 may also be used to connect the tip 110 and shaft 130; other types of structures may also be used in place of the ferrule 120 to connect the tip side of the shaft to the tip 110 of the cue stick 100. Cue sticks may have a unitary body construction that includes both the shaft and the handle section. Alternatively, the cue stick may be made of two pieces, the shaft section piece and the handle section piece, that are detachably connectable. Cue sticks may also be constructed of three or more detachably connectable pieces. Because of the preference of billiard game players to utilize cue sticks having a shaft outer diameter of about 0.5 inches close to the tip of the stick, related embodiments of the invention include this outer diameter dimension.

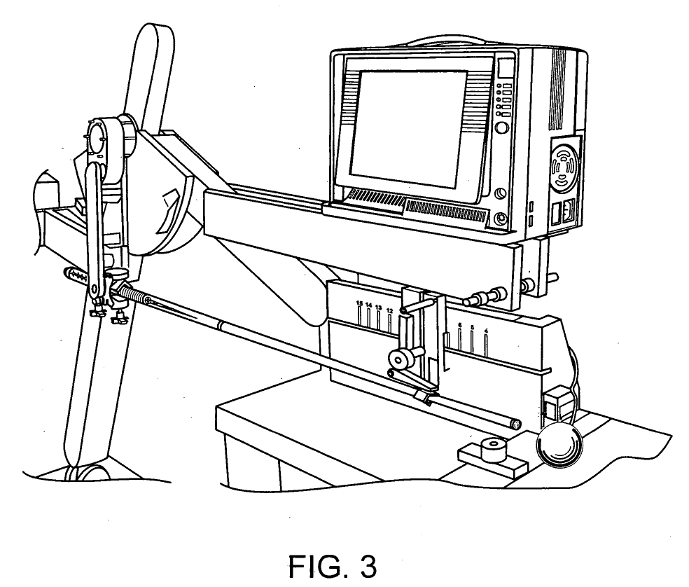

Experimental cue ball deflection measurements, discussed herein, were performed using a robotic arm to stroke a cue stick with a particular force in a straight line to strike a cue ball. The robot, shown in FIG. 3, has a number of discrete bridge settings and spring settings to control the stroking of the cue stick. In the tests described herein, the choice of a particular bridge and spring setting results in a consistent force being imparted to struck cue balls. The robotic arm strokes the cue in a straight line, known herein as the “stroke line.” The stroke line is parallel to a line intersecting the center of mass of the struck cue ball. A zero deflection location is determined at a distance of 50 inches from the point at which the cue ball is struck along a line collinear with the stroke line. The actual location of the ball after traveling 50 inches from impact is noted. The difference between the zero deflection location and the actual location is the cue ball deflection or “squirt”. Another measure of cue ball deflection is the “squirt angle.” This is defined as the angle formed by the intersection of a line connecting the impact location and zero deflection location, and a line connecting the impact location and the actual location.

Mass Distribution

To determine the effect of mass distribution on cue ball deflection, the robotic arm was used at particular bridge and spring settings to replicate the force of a particular shot. Each shot was performed using the same 9 mm offset between the stroke line and center of mass line of the struck cue ball. Four shots were performed using an unmodified Predator Pool Cue (Model 314), the average squirt and squirt angle over the four shots being calculated.

In a first series of shots, lead tape was circumferentially wrapped outside the cue stick within an inch of the tip end to add 1 gram of mass to the first inch of the cue. Four separate shots were performed, the squirts and squirt angles of the four trials were used to calculate average squirt and squirt angle values. Next, more lead tape was circumferentially wrapped within an inch of the tip such that the total added mass was 2 grams. Four more shots were performed; an average value of squirt and squirt angle was calculated based on these shots. Next, more lead tape was added to increase the mass to 3 grams within an inch of the tip of the cue stick. Corresponding average values of squirt and squirt angle were calculated based on four more shots using the cue having 3 grams of added mass in the first inch of the stick.

For the next series of shots, the lead tape was removed from the first inch of the cue stick. Lead tape was applied to the second inch of the cue stick from the tip to add an additional 1 gram of mass. The cue was used to perform four shots to determine squirts and squirt angles, an average value of squirt and squirt angle being subsequently calculated. Shots and average calculated values of squirt and squirt angle were determined for each subsequent modification of the cue that adds a total of 2 and 3 grams of mass within the second inch of the tip of the cue stick.

Subsequent series of shots repeat the procedure described above for each individual inch of the cue from the tip of the stick, up to a distance of about six inches. The results of the difference between the calculated average values of squirt at each inch of the tested cue and squirt of the unmodified cue is summarized in Table 1, along with the corresponding differences between calculated squirt angles and unmodified cue squirt angle.

TABLE 1
Summary of Mass Distribution Experiments
on a Predator 314 Cue

| | Squirt | | | |
|---|---|---|---|---|
| | increase | Angular squirt | Percent | Relative |
| | per gram | increase per | increase in | Influence of |
| | added | gram added | squirt per | additional |
| | (mm) | (degrees) | gram added | mass added |
| 1^{st} inch | 2.7 | 0.244 | 7.7 | 30% |
| 2^{nd} inch | 2.1 | 0.190 | 6.0 | 24% |
| 3^{rd} inch | 1.65 | 0.149 | 4.7 | 19% |
| 4^{th} inch | 1.35 | 0.122 | 3.9 | 15% |
| 5^{th} inch | 0.8 | 0.072 | 2.3 | 9% |
| 6^{th} inch | 0.3 | 0.027 | 0.9 | 3% |

The data from Table 1 supports the conclusion that mass closer to the tip end of a cue stick results in more cue ball deflection than an equivalent mass located further back from the tip, even within the first six inches of the cue stick. Thus, reduced cue ball deflection is more readily achieved by distributing the reduction closer to the tip end of the cue stick. The table also supports the conclusion that reducing the mass of the tip and any connector (e.g., a ferrule) between the tip and shaft of a cue stick may be more important than reducing the mass in the tip end of the shaft, for a given mass reduction.

The data from Table 1 also implicitly provides the conclusion that the relationship between mass of the tested shaft and cue ball deflection is approximately linear over the tested range, i.e., each gram of additional mass at a given location relative to the tip of the cue stick results in an equal additional amount of cue ball deflection.

Further data regarding the effect of mass distribution on cue ball squirt is presented in Table 2.

TABLE 2
Mass Distribution and Cue Ball Deflection of Experimental and Commercially Available Cues

| | | | | | | | Total | | | | |
|---|---|---|---|---|---|---|---|---|---|---|---|
| | 1^{st} | 2nd | 3rd | 4th | 5th | 6th | mass | | | Observed | Predicted |
| | inch | inch | inch | inch | inch | inch | (g) | Observed | Predicted | Squirt | Squirt |
| | mass | mass | mass | mass | mass | mass | in 6 | Squirt | Squirt | angle | angle |
| | (g) | (g) | (g) | (g) | (g) | (g) | inches | (mm) | (mm) | (degrees) | (degrees) |
| Mizerak | 3.14 | 3.85 | 3.2 | 2.16 | 2.16 | 2.16 | 16.67 | 42.6 | 45.1 | 3.85 | 4.05 |
| Composite | | | | | | | | | | | |
| Model P0347 | | | | | | | | | | | |
| Joss | 3.86 | 2.7 | 2.33 | 2.33 | 2.33 | 2.33 | 15.88 | 44.2 | 43.6 | 3.99 | 3.92 |
| Viking | 3.18 | 2.34 | 2.16 | 2.2 | 2.25 | 2.3 | 14.43 | 41.7 | 40.5 | 3.77 | 3.63 |
| Adams carom | 2.62 | 2.03 | 2.16 | 2.29 | 2.42 | 2.56 | 14.08 | 38.5 | 38.7 | 3.48 | 3.47 |
| Predator 314 | 2.91 | 1.33 | 1.55 | 1.66 | 1.7 | 1.97 | 11.12 | 34.8 | 35.4 | 3.14 | 3.17 |
| Predator Z | 2.37 | 1.37 | 1.43 | 1.49 | 1.54 | 1.65 | 9.85 | 32.3 | 33.4 | 2.92 | 2.99 |
| Experimental | 1.95 | 1.17 | 1.24 | 1.33 | 1.4 | 1.48 | 8.57 | 29.2 | 31.1 | 2.64 | 2.79 |
| Cue 1 | | | | | | | | | | | |

The mass distribution for six commercially available billiard game cues is calculated based upon the properties of the materials of each cue and the geometry of the cue. In addition, a cue (labeled Experimental Cue 1) was constructed of carbon fiber/epoxy, with a mass distribution as summarized in Table 2, to provide enhanced reduction of cue ball deflection.

The mass of each inch for each of the first six inches of each tested cue, extending from the tip toward the butt end, is calculated in Table 2, along with the total mass in the first six inches of each cue. As well, the average squirt and squirt angle from a series of repeated shots using a 9 mm offset and the same settings as used for the testing to generate Table 1 was obtained. Results for each of the six commercially available cues, and Experimental Cue 1, is recorded under the headings “Observed Squirt” and “Observed Squirt Angle.”

Table 2 shows that observed squirt and squirt angle decreases as the total mass of the cue stick in the first six inches decreases. In particular, Experimental Cue 1, having a lower total mass in the first six inches than any of the commercially available cues, exhibits 10% less observed squirt than any other tested cue in Table 2.

Table 2 also presents the result that the correspondence between mass distribution and cue ball deflection given in Table 1 accurately predicts the cue ball deflection of all the tested cues in Table 2. In particular, a predicted squirt value of cue ball deflection for each tested cue in Table 2 is calculated using the Equation 1.

$$PS = {S}_{o} + {\sum }_{i = 1}^{6} {σ}_{i} {m}_{i} \qquad ( Eq . 1 )$$

wherein PS is the predicted squirt value; S₀ is a non-mass associated squirt constant for all tested cues; σᵢ is the squirt per gram in the i^{th} inch of the cue from the tip end as determined in Table 1; and mᵢ is the mass of the i^{th} inch of the tested cue from the tip end (as shown in Table 2). Using a value for S₀ of 18.0 mm for all tested cues, PS values for each tested cue are calculated using Eq. 1 and presented in Table 2.

The good agreement between the calculated values of PS and the corresponding average observed values of squirt indicates that mass distribution conclusions derived from the results of Table 1 are applicable to all cues. Thus, it is generally true that the reduced mass at the tip end of a cue stick is relatively more important than an equal amount of reduced mass further from the tip.

Correspondingly, the squirt angle may be predicted using Equation 2.

$$PSA = {SA}_{o} + {\sum }_{i = 1}^{6} {α}_{i} {m}_{i} \qquad ( Eq . 2 )$$

wherein PSA is the predicted squirt angle, SA₀ is a non-mass associated squirt angle constant for all tested cues; αᵢ is the squirt angle per gram in the i^{th} inch of the cue from the tip end as determined in Table 1; and mᵢ is the mass of the i^{th} inch of the tested cue from the tip end (as shown in Table 2). Applying Eq. 2 with the squirt angle data of Tables 1 and 2, where SA₀ is 1.6 degrees for all tested cues, generates the predicted squirt angle values in Table 2. Again, good agreement between the observed squirt angles and the corresponding predicted squirt angles confirms the validity of the mass distribution conclusions as applied to all tested cues.

Furthermore, a cue stick with improved cue ball deflection properties may be obtained by constructing a cue with less cumulative mass over a given length, from the tip to a distance of about 1, 2, 3, 4, 5, or 6 inches toward the butt end, than the commercially available cue with the least amount of squirt (i.e., the Predator Z). Thus, in an embodiment of the invention, a cue stick with improved cue ball deflection properties is comprised of a section extending from a tip toward the butt end of the cue stick. The section has a mass distribution, wherein each corresponding inch of the section has a mass no greater than a corresponding mᵢ, and at least one corresponding inch of the section has a mass less than a corresponding mᵢ, where the set of mᵢ's corresponds with that of the Predator Z shaft. Another alternative embodiment is directed to a cue stick configured to have less cue ball deflection than the predicted cue ball deflection according to Eq. 1, wherein the parameters for Eq. 1 correspond with those for the Predator Z shaft.

In an embodiment of the invention, a cue stick comprises a section extending from the tip of the stick toward the butt end of the stick. The section extends for a particular distance and has a total mass no greater than a particular value. In one particular embodiment, the section has a length of about 1 inch (in), and a mass less than about 2.3 grams (g), more preferably less than about 2.2 g, and even more preferably less than about 2.0 g. In a second particular embodiment, the section has a length of about 2 in, and a mass less than about 3.7 g, more preferably less than about 3.6 g, and even more preferably less than about 3.4 g. In a third particular embodiment, the section has a length of about 3 in, and a mass less than about 5.1 g, more preferably less than about 5.0 g, and even more preferably less than about 4.8 g. In a fourth particular embodiment, the section has a length of about 4 in, and a mass less than about 6.6 g, more preferably less than about 6.5 g, and even more preferably less than about 6.3 g. In a fifth particular embodiment, the section has a length of about 5 in, and a mass less than about 8.1 g, more preferably less than about 8.0 g, and even more preferably less than about 7.8 g. In a sixth particular embodiment, the section has a length of about 6 in and a mass less than about 9.8 g, more preferably less than about 9.7 g, and even more preferably less than about 9.5 g. The above embodiments of the invention reduce cue ball deflection by not only reducing the mass toward the tip end of the shaft but by (i) reducing the mass contributions of the tip and any connector such as a ferrule; and (ii) distributing the reduction of mass toward the tip end of the cue stick to enhance the effect of reducing cue ball deflection.

The reduction of mass in the tip end of the cue stick, and the distribution of the reduced mass, may be achieved using any method known to those of ordinary skill in the art. For example, as shown in FIG. 2A, the tip end 200 of the cue stick includes a tip 210, a plug connector 220, and a hollow shaft 231. The bore 232 may be empty or alternatively filled with a lightweight material, preferably having a lower density than the shaft wall. For example, the bore 232 can be filled with a structural foam material. The bore may also have a constant diameter, be tapered, or undergo discrete changes at predetermined locations to achieve a particular mass distribution in the tip end section of the cue. The bore configuration and the choice of materials for the tip 210, plug connector 220, and hollow shaft 231 determine the mass of the tip end of the cue stick, and also the distribution of the mass. In another example depicted in FIG. 2B, the tip end 205 of the cue stick includes a solid shaft 236. The mass and mass distribution are determined by the choice of materials for the tip 215, plug connector 225, and the shaft 236. Composite materials, such as carbon fiber/epoxy mixtures, may be engineered to have superior strength. By utilizing such materials in tube-like structures, less overall material may be used to achieve a reduction in mass. Spruce wood that is bored may also provide a suitable material and configuration. As well, mixtures of materials may also provide the desired mass distribution (e.g., a bored or solid wood core, rod-like or tapered, with a composite skin layer). In addition, the tip end of the cue may be reduced in mass by replacing a ferrule with a tip plate. The tip plate is a thin piece of carbon fiber having high stiffness and low mass, thus allowing reduction of mass near the tip. The tip is attached to the tip plate with adhesive, and the plate attached to the tip end of a hollow shaft to seal the tip end. Details of the tip plate can be found in a U.S. Provisional Application having Ser. No. 60/668,679, filed Apr. 6, 2005. The entire contents of the application are hereby incorporated by reference herein.

Measures of Stiffness

Table 3 presents mechanical properties of seven commercially available cues and three experimental cues constructed by the Applicants. The experimental cues were designed to provide enhanced cue ball deflection properties relative to the prior art. Calculations regarding flexural modulus, moment of inertia, bending stiffness, average mass/length of shaft, and specific section modulus all assume that the section of cue being examined is tubular or rod shaped in construction, i.e., the outer diameter maintains a constant value. Though the tested cues include cues having a tapered outer diameter, the tube/rod configuration assumption provides a reasonable approximation in most instances given the low gradation of the taper. The values for the shaft diameter and wall thickness are effectively averaged over about a six inch length from the tip end of the shaft toward the butt end of the shaft.

TABLE 3
Mechanical Properties of Experimental and Commercially Available Cues

| | Shaft | Wall | | | Flexural | Moment | Bending | Average mass/ | Specific Section |
|---|---|---|---|---|---|---|---|---|---|
| | diameter | thickness | Configuration/ | Density | Modulus, | of Inertia, | Stiffness, | length of shaft, | Modulus, EI/ρ₁ |
| | (in) | (in) | Material | (g/in³) | E (Mpsi) | I (in⁴) | EI (lb_{f} in²) | ρ₁ (g/in) | (lb_{f} in³/g) |
| Mizerak | 0.510 | 0.050 | tube/fiberglass | 31 | 3.1 | 0.0019 | 5890 | 2.23 | 2639 |
| Composite | | | | | | | | | |
| Model P0347 | | | | | | | | | |
| typical | 0.450 | N/A | rod/maple | 11 | 1.8 | 0.002 | 3600 | 1.75 | 2058 |
| snooker cue | | | | | | | | | |
| Joss | 0.520 | N/A | rod/maple | 11 | 1.8 | 0.0036 | 6480 | 2.33 | 2779 |
| Viking | 0.510 | N/A | rod/maple | 11 | 1.8 | 0.0033 | 5940 | 2.24 | 2647 |
| Adams carom | 0.500 | N/A | rod/maple | 11 | 1.8 | 0.0031 | 5580 | 2.16 | 2588 |
| Predator 314 | 0.510 | 0.120 | tube/maple | 11 | 1.8 | 0.00306 | 5508 | 1.62 | 3406 |
| Predator Z | 0.480 | 0.115 | tube/maple | 11 | 1.8 | 0.0024 | 4320 | 1.45 | 2975 |
| Experimental | 0.480 | 0.035 | tube/ | 25 | 9 | 0.0012 | 10800 | 1.23 | 8816 |
| Cue 1 | | | carbon-epoxy | | | | | | |
| Experimental | 0.500 | 0.030 | tube/ | 25 | 9 | 0.0012 | 10800 | 1.10 | 9818 |
| Cue 2 | | | carbon-epoxy | | | | | | |
| Experimental | 0.500 | 0.020 | tube/ | 25 | 9 | 0.0009 | 8100 | 0.75 | 10800 |
| Cue 3 | | | carbon-epoxy | | | | | | |

Portions of the shafts of cue sticks in Table 3 extend from a tip end of the shaft toward the butt end of the shaft. The shafts are assumed to have either a rod configuration (i.e., a solid rod with uniform cross sectional area along the axis of the rod), or a tube configuration (i.e., a tube having an empty cylindrical volume, the tube having uniform cross sectional area along the axis of the tube).

The flexural modulus, E, is a property of the material used to construct the shaft. The moment of inertia, I, is a function of the geometry of the shaft. For a rod configuration,

$$I ( rod ) = \frac{π}{4} {R}^{4}$$

where R is the outer diameter of the rod. For a tube configuration,

$$I ( tube ) = \frac{π}{4} ( {R}^{4} - {r}^{4} )$$

where R is the outer diameter of the tube and r is the inner diameter of the tube.

The bending stiffness, EI, is the product of the flexural modulus and moment of inertia. EI has units of force times length². EI provides a measure of the stiffness of an object that is a function both of the material used to make the object and the configuration of the object.

The average mass/length of shaft, ρ₁, is a measurement of the mass accumulated per length of shaft. ρ₁ is the product of the density of the material times the solid cross sectional area of the shaft. Thus, for a rod configuration, ρ₁=ρπR², where ρ is the density of the material. For a tube configuration, ρ₁=ρπ(R²−r²).

The specific section modulus, SSM, is defined as EI/ρ₁. SSM has units of length⁴/time². Herein, however, we use SSM units of lb_{f} in³/g for convenience, where lb_{f} has units of mass length/time². The specific section modulus provides a measure of the quickness of a configured object to return to an original equilibrium state. The higher the specific section modulus, the higher the natural frequency.

From testing done by the Applicants, it has been determined that a value of bending stiffness, EI, exists below which cue ball deflection is accentuated for shots utilizing high velocities and a high offset between the stroke line and the line traveling through the center of mass of the struck ball. This phenomenon is more readily understood with respect to the experimental results presented in Table 4 and the detailed discussion below.

TABLE 4
Experimental Results of Squirt as a Function of Speed and Offset

| | Predator Z shaft | | | Predator 314 shaft | | | Experimental Cue 1 | | |
|---|---|---|---|---|---|---|---|---|---|
| | (EI = 4320 lb_{f} in²) | | | (EI = 5508 lb_{f} in²) | | | (EI = 10,800 lb_{f} in²) | | |
| | Squirt (mm) | Squirt (mm) | Squirt (mm) | Squirt (mm) | Squirt (mm) | Squirt (mm) | Squirt (mm) | Squirt (mm) | Squirt (mm) |
| | at about | at about | at about | at about | at about | at about | at about | at about | at about |
| | 11.5 ft/sec | 16.1 ft/sec | 22 ft/sec | 11.5 ft/sec | 16.1 ft/sec | 22 ft/sec | 11.5 ft/sec | 16.1 ft/sec | 22 ft/sec |
| 6 mm offset | 22.1 | 22.1 | 21.8 | 23.2 | 22.9 | 22.9 | 20.3 | 20.1 | 19.2 |
| 12 mm offset | 41.5 | 42.6 | 43.8 | 45.6 | 46.8 | 47.9 | 38.1 | 37.2 | 36.9 |
| 15 mm offset | 50.6 | 54.4 | 56.5 | 58.2 | 62.3 | 66.2 | 46.8 | 45.9 | N/A |

Three cue sticks, two commercially available cues from Predator Products and Experimental Cue 1, were tested under a variety of conditions to assess trends in cue ball deflection. Each cue stick is used to determine the amount of squirt under 9 separate shot conditions. Specifically, offsets of 6 mm, 12 mm, and 15 mm, between the stroke line and the line traveling through the center of mass of the struck ball, are examined. As well, shots are made at velocities of about 11.5 ft/sec, 16.1 ft/sec, and 22 ft/sec.

The results of the testing indicate that for the Predator Z and 314 shafts, having bending stiffnesses of 4320 lb_{f} in² and 5508 lb_{f} in², respectively, the amount of squirt increases as both the offset is increased and the velocity of the shot is increased.

It has been experimentally determined that as the bending stiffness, EI, decreases, the phenomenon of accentuated cue ball deflection at high velocities and high offsets becomes more acute. On the other hand, increasing EI can cause a reversal in the observed trend of cue ball deflection. As shown in the results of Table 4 for Experimental Cue 1, having a bending stiffness of 10,800 lb_{f} in², the cue ball deflection actually decreases with increasing velocity. Also, in general, the amount of cue ball deflection is less, as are the changes at different velocities for a given offset.

The phenomenon of accentuated cue ball deflection is also dependent upon the type of billiard game played. Pool games utilize different ball sizes and masses relative to snooker for example. Based upon the experience of the Applicants, a minimum bending stiffness of about 3600 lb_{f} in² would be useful in decreasing the effect of high velocity/high offset cue ball deflection in games such as snooker. For pool games, the bending stiffness is greater than about 4300 lb_{f} in² to obtain an acceptable level of cue ball deflection at high offsets/high velocities. For carom, bending stiffnesses greater than about 5600 lb_{f} in² may be advantageous in reducing cue ball deflection.

In the context of the properties shown in Table 3, the values of bending stiffness are averaged over a distance of 4, 5, 6, 7, or 8 inches of a shaft from the tip end traveling toward the butt end. The tip and ferrule, or other similar type device, also have properties that affect the overall bending stiffness at the tip end of the cue stick, and thus the cue ball deflection properties. Thus, embodiments of the invention utilize the limits of bending stiffness discussed herein in the design of the tip end of the shaft and/or the tip end of the cue stick.

Referring back to Table 4, the high bending stiffness of the Experimental Cue 1, and the reversal in cue ball deflection with velocity, suggests that an intermediate range of EI exists in which cue ball deflection remains relatively unchanged with respect to velocity. A cue stick with this property would be potentially advantageous to players since any adjustment to cue ball deflection varies directly with the offset, and is not a function of the velocity of the stroke. Thus, in an embodiment of the invention, a cue stick comprises a section with a bending stiffness, or a range of bending stiffnesses, determined such that variation in cue ball deflection with ball velocity is minimized, or kept below a predetermined value. Such an embodiment may be combined with a distribution of mass reduction to the tip end of the cue stick, as described by previous embodiments of the invention, to decrease the constant value of cue ball deflection.

It has also been shown that a maximum value of specific section modulus, all other things being equal, exists to reduce cue ball deflection. As shown in Table 3, Experimental Cue 3 possesses an SSM of 10,800 lb_{f} in³/g. It has been observed that the cue possessing this very high SSM value for the shaft exhibits a double strike phenomenon. When an offset shot is performed with Experimental Cue 3, the natural frequency of the shaft is so high that the tip end of the cue stick deflects and vibrates back toward its equilibrium position before a struck ball leaves the vicinity of the ball strike. The cue actually strikes the ball again upon this recoil, effectively disrupting the accuracy of the shot.

In contrast, Experimental Cue 2, having an SSM of about 9800 lb_{f} in³/g as shown in Table 3, does not exhibit the double strike phenomenon. Thus, it is conjectured that shafts having an SSM below about 10,000 lb_{f} in³/g avoid the double strike phenomenon. Such a limit in SSM is advantageous in the design of cues for pool type play. The SSM limit also places a potential limit on mass reduction to achieve reduced cue ball deflection since a decrease in density will result in a higher SSM.

In other types of billiards games, however, the limitation on SSM may be raised or lowered depending upon the factors such as the mass of the ball (e.g., since snooker is played with lighter balls, a lower limit than 10,000 lb_{f} in³/g for specific section modulus would probably be required to avoid the double hit phenomenon). As well, a break cue for pool may employ a cue stick with a shaft having a greater maximum SSM since the break stroke is typically oriented more along the stroke line than an english shot. As well, maximizing energy and momentum transfer along the centerline of the cue ball suggests that enhanced SSM is a desired property.

As discussed earlier with respect to bending stiffness, the properties of the actual tip and ferrule may change the stiffness properties of the cue stick at the tip end, thus altering the cue ball deflection properties. Thus, embodiments of the invention may establish an SSM below 10,000 lb_{f} in³/g averaged over a section of the cue stick from the tip back toward the butt end of the cue stick, as opposed to just the shaft without the tip or connector.

Thus, in some embodiments of the invention, a cue stick has a predetermined minimum bending stiffness. In particular, the bending stiffness is greater than about 3600 lb_{f} in². Alternatively, the bending stiffness is greater than about 4300 lb_{f} in². In another alternative, the bending stiffness is greater than about 5600 lb_{f} in². In another related embodiment, a cue stick has a predetermined maximum specific section modulus. Preferably, the cue stick has a specific section modulus less than about 10,000 lb_{f} in³/g. For each of the embodiments regarding the measures of stiffness, the value of bending stiffness or specific section modulus may be averaged over about 4, 5, 6, 7, or 8 inches of the cue stick from the tip toward the butt end of the stick. In related embodiments of the invention, one or more limitations on bending stiffness or specific section modulus discussed herein are applied to the shaft of a cue stick from the tip end of the shaft toward the butt end of the shaft averaged over a distance of about 4, 5, 6, 7, or 8 inches.

Flexural Node Engineering

The node point of a cue stick acts as the effective “fixed point” where bending occurs in a cue during an off center cue strike. For example, when performing off center shots with a cue, the node point is identified as the location along the cue where placement of a bridge would result in a local minimum in cue ball deflection, i.e., moving the bridge point slightly away in either direction results in an increase in cue ball deflection. Consistent with experiments conducted on various cues, the node point is located anywhere within the range of about 4 to about 8 inches from the tip end of the cue stick, preferably at about 5.5 to about 7 inches.

Embodiments of the invention are directed to a cue stick having a shaft configured such that the bending stiffness is altered, or undergoes a substantial change, around the node point. This enhances flexing at the node point. With enhanced flexing characteristics, the cue should flex more easily at the node, and impart less momentum to a cue ball when the momentum component is not in the direction of the stroke line. Therefore, cue ball deflection is reduced. In a related embodiment of the invention, the bending stiffness at the node point is reduced while maintaining compressive stiffness above a threshold value. Such an embodiment reduces any loss of momentum transfer through the cue in the direction of the stroke line.

Bending stiffness alterations at a node point may be achieved in any number of ways. One method involves filament winding of carbon fibers, wherein the orientation of the windings of a carbon fiber, pulled through a resin bath and wound around a mandrel, are altered around the node point to decrease the bending stiffness (e.g., the angle of the winding relative to the radial direction of the cue may be made more acute near the node point). Another method utilizes sheets of carbon fibers, preimpregnated with resin, to form a section of the cue stick. Some sheets forming the structure in the neighborhood of the node point have carbon fibers aligned in a particular orientation at to reduce the bending stiffness near or at the node point upon moulding. In another embodiment of the invention, particular geometrical changes are made in a cue at the node point to reduce the bending stiffness at that local position. For example, cutting a circumferential groove in the outer layer of a cue at the node point results in a decrease in bending stiffness since the bending stiffness is proportional to the moment of inertia, I, which is proportional to radius⁴. Other methods, as known to those of ordinary skill, may also be applied.

In an experiment to test the effect of reducing bending stiffness at the node on cue ball deflection, the squirt of a solid maple cue was determined before and after a modification. First, a 9 mm offset shot was performed using the unmodified solid maple cue, resulting in a squirt of 37.3 mm at 50 inches. Since the thickness of the cue at the node point is about 0.48 inches, the bending stiffness is calculated as about 4680 lb_{f} in².

Next the bending stiffness at the node of the wooden cue was altered by cutting 3 parallel circumferential grooves on the outside of the cue stick at the node of the cue, which is at about 5.5 inches. Each groove is about 0.1 inches deep and about 0.08 inches wide. The grooves are separated by a distance of about 0.08 inches. By averaging the bending stiffness between the uncut and cut portions at the node, a bending stiffness of about 2600 lb_{f} in² is estimated at the node point of the maple cue.

Subsequent to the modification, a 9 mm offset shot with the same settings as used with the unmodified maple cue results in a squirt of 34.7 mm. Thus, the reduction of bending stiffness at the node results is 7% less cue ball deflection.

More generally, the composition of the cue can be altered at or near a specific node in the shaft to “fine tune” the performance of the cue. For example, Boron, glass, plastic, Kevlar or similar light weight material can be incorporated into the cue at or near a specific node point to “fine tune” the playability of composite jump, break and/or playing shafts, and to allow for the ability to change the vibration dampening and acoustic attenuation. The material can be used to increase the stiffness of the cue at or near the node point, or to reduce the stiffness of the cue at or near the node point, relative to the rest of the cue shaft.

In one example, the composition of the cue at the node point can be altered by the addition of a sleeve of a light weight material over the shaft, localized at or near the node point. In other embodiments, the cue can be a composite cue, and the light-weight material(s) at the node can be incorporated directly into the cue during the formation of the composite cue. A preferred material to be incorporated at the node point is Boron, due to its advantageous combination of light weight and strength.

It will be understood that cue sticks can include a plurality of “node” points along the length of the shaft, and the composition of the cue can be altered at or near any of these nodes in order to “fine tune” the cue's performance. In many conventional cue sticks, node points exist at approximately 6 inches, 9 inches, 12 inches and 15 inches from the tip end of the cue stick.

Other embodiments of the invention utilize the features of cue sticks in previously described embodiments of the invention. In one embodiment, a shaft section of a cue stick comprises a tip, a connector (such as a ferrule), and a shaft of a cue stick. The shaft section is detachably connectable to a handle section, or a plurality of other sections, to form a cue stick. The shaft section includes any of the limitations utilized in embodiments of the invention for cue sticks. Thus, in a particular embodiment, the shaft section has a mass less than a particular value over a predetermined length from the tip toward the butt end of the shaft section, the particular value of mass and predetermined length being any of those utilized in embodiments related to cue sticks. The shaft section could comprise a replacement shaft section, or a tip section of a particular length (6 inches, for instance) that is designed as a retrofit for an existing cue.

Another embodiment of the invention is directed toward a method of reducing ball deflection when making an off center ball strike. The method includes the step of providing a cue stick or a shaft section of a cue stick consistent with any of the previous embodiments of the invention described herein. The ball is struck with the cue stick by propelling the cue stick in a line-like direction (e.g., a straight line according to a player making a ball strike) in which the line does not travel through the center of mass of the ball, resulting in reduced cue ball deflection. Such a method is especially advantageous to players of billiards games who cannot accommodate for the accentuated ball deflection during a cue ball shot.

While this invention has been particularly shown and described with references to preferred embodiments thereof, it will be understood by those skilled in the art that various changes in form and details may be made therein without departing from the scope of the invention encompassed by the appended claims.

What is claimed is:

1. A cue stick comprising:
a section extending from a tip of the cue stick toward a butt end of the cue stick for about 3 inches, the section having a mass less than about 5.1 grams.

2. The cue stick of claim 1 further comprising:
a second section including the first section, the second section extending from the tip of the cue stick toward the butt end of the cue stick, the second section having a length of at least about 4 inches, the second section having a bending stiffness greater than about 3600 lb_{f} in² averaged over the length of the second section.

3. The cue stick of claim 2, wherein the bending stiffness of the second section is greater than about 4300 lb_{f} in² averaged over the length of the second section.

4. The cue stick of claim 3, wherein the bending stiffness of the second section is greater than about 5600 lb_{f} in² averaged over the length of the second section.

5. The cue stick of claim 1 further comprising:
a shaft having a bending stiffness greater than about 3600 lb_{f} in² averaged over at least about 4 inches of the shaft from a tip end of the shaft toward a butt end of the shaft.

6. The cue stick of claim 5, wherein the shaft includes a bore extending from the tip end of the shaft toward the butt end of the cue stick.

7. The cue stick of claim 6, wherein the bore is hollow.

8. The cue stick of claim 6, wherein the bore is at least partially filled with a material having a lower density than a density of a wall of the shaft.

9. The cue stick of claim 5, wherein the shaft has a bending stiffness greater than about 4300 lb_{f} in² averaged over at least about 4 inches of the shaft from the tip end of the shaft toward the butt end of the shaft.

10. The cue stick of claim 9, wherein the shaft has a bending stiffness greater than about 5600 lb_{f} in² averaged over at least about 4 inches of the shaft from the tip end of the shaft toward the butt end of the shaft.

11. The cue stick of claim 5, wherein the shaft is comprised of a composite material.

12. The cue stick of claim 1 further comprising:
a shaft including the section, the shaft having a specific section modulus less than about 10000 lb_{f} in³/g averaged over at least about 4 inches of the shaft from the tip end of the shaft toward the butt end of the shaft.

13. The cue stick of claim 1, wherein the section extending from a tip of the cue stick toward a butt end of the cue stick for about 3 inches has a mass of about 4.8 grams or less.

14. A cue stick comprising:
a section extending from a tip of the cue stick toward a butt end of the cue stick for about 1 inch, the section having a mass less than about 2.3 grams.

15. The cue stick of claim 14, wherein the section extending from a tip of the cue stick toward a butt end of the cue stick for about 1 inch has a mass of about 2.0 grams or less.

16. A cue stick comprising:
a section extending from a tip of the cue stick toward the butt end of the cue stick for about 2 inches, the section having a mass less than about 3.7 grams.

17. The cue stick of claim 16, wherein the section extending from a tip of the cue stick toward a butt end of the cue stick for about 2 inches has a mass of about 3.4 grams or less.

18. A cue stick comprising:
a section extending from a tip of the cue stick toward the butt end of the cue stick for about 4 inches, the section having a mass less than about 6.6 grams.

19. The cue stick of claim 18, wherein the section extending from a tip of the cue stick toward a butt end of the cue stick for about 4 inches has a mass of about 6.3 grams or less.

20. A cue stick comprising:
a section extending from a tip of the cue stick toward the butt end of the cue stick for about 5 inches, the section having a mass less than about 8.1 grams.

21. The cue stick of claim 20, wherein the section extending from a tip of the cue stick toward a butt end of the cue stick for about 5 inches has a mass of about 7.8 grams or less.

22. A cue stick comprising:
a section extending from a tip of the cue stick toward the butt end of the cue stick for about 6 inches, the section having a mass less than about 9.8 grams.

23. The cue stick of claim 22, wherein the section extending from a tip of the cue stick toward a butt end of the cue stick for about 6 inches has a mass of about 9.5 grams or less.

24. A cue stick comprising:
a first section extending from a tip of the cue stick toward a butt end of the cue stick, the first section having a mass distribution that satisfies one or more of the following:
a) the first section is approximately 1 inch in length, and has a mass less than about 2.3 grams;
b) the first section is approximately 2 inches in length, and has a mass less than about 3.7 grams;
c) the first section is approximately 3 inches in length, and has a mass less than about 5.1 grams;
d) the first section is approximately 4 inches in length, and has a mass less than about 6.6 grams;
e) the first section is approximately 5 inches in length, and has a mass less than about 8.1 grams; and
f) the first section is approximately 6 inches in length, and has a mass less than about 9.8 grams.

25. The cue stick of claim 24, further comprising:
a second section extending from the tip of the cue stick toward the butt end of the cue stick, the second section coinciding with the first section for at least a portion of its length, the second section having a length of at least about 4 inches, and a bending stiffness greater than about 3600 lb_{f} in² averaged over the length of the second section.

26. The cue stick of claim 25, wherein the second section is less than about 8 inches in length.

27. The cue stick of claim 26, wherein the bending stiffness of the second section is greater than about 4300 lb_{f} in² averaged over the length of the second section.

28. The cue stick of claim 26, wherein the bending stiffness of the second section is greater than about 5600 lb_{f} in² averaged over the length of the second section.

29. The cue stick of claim 26, wherein the cue stick has a specific section modulus less than about 10000 lb_{f} in³/g averaged over the second section.

30. A cue stick comprising:
a shaft having a predetermined bending stiffness at a node of the cue stick, the predetermined bending stiffness being lower than a bending stiffness at positions adjacent to the node of the cue stick.

31. The cue stick of claim 29, wherein the cue stick comprises carbon fibers, wherein the orientation of the fibers is altered around the node relative to the orientation of the fibers at positions adjacent to the node to provide the predetermined bending stiffness at the node.

32. The cue stick of claim 30, wherein the predetermined bending stiffness at the node is provided by a geometrical feature of the cue stick, located at or near the node point.

33. The cue stick of claim 32, wherein the geometrical feature comprises one or more circumferential grooves in the outer layer of the cue stick at or near the node point.

34. A method of reducing ball deflection when making an off-center ball strike, comprising:
striking a ball with a cue stick along a line that does not travel through the center of mass of the ball, the cue stick comprising a first section extending from a tip of the cue stick toward a butt end of the cue stick, the first section having a mass distribution that satisfies one or more of the following:
a) the first section is approximately 1 inch in length, and has a mass less than about 2.3 grams;
b) the first section is approximately 2 inches in length, and has a mass less than about 3.7 grams;
c) the first section is approximately 3 inches in length, and has a mass less than about 5.1 grams;
d) the first section is approximately 4 inches in length, and has a mass less than about 6.6 grams;
e) the first section is approximately 5 inches in length, and has a mass less than about 8.1 grams; and
f) the first section is approximately 6 inches in length, and has a mass less than about 9.8 grams.

35. The method of claim 34, wherein the cue stick comprises a second section extending from the tip of the cue stick toward the butt end of the cue stick, the second section coinciding with the first section for at least a portion of its length, the second section having a length of at least about 4 inches, and a bending stiffness greater than about 3600 lb_{f} in² averaged over the length of the second section.

36. A method of manufacturing a cue stick, comprising
providing a cue stick having a tip and a butt end, the cue stick having first section extending from the tip of the cue stick toward the butt end, the first section having a mass distribution that satisfies one or more of the following:
a) the first section is approximately 1 inch in length, and has a mass less than about 2.3 grams;
b) the first section is approximately 2 inches in length, and has a mass less than about 3.7 grams;
c) the first section is approximately 3 inches in length, and has a mass less than about 5.1 grams;
d) the first section is approximately 4 inches in length, and has a mass less than about 6.6 grams;
e) the first section is approximately 5 inches in length, and has a mass less than about 8.1 grams; and
f) the first section is approximately 6 inches in length, and has a mass less than about 9.8 grams.

37. The method of claim 36, wherein the cue stick comprises a second section extending from the tip of the cue stick toward the butt end of the cue stick, the second section coinciding with the first section for at least a portion of its length, the second section having a length of at least about 4 inches, and a bending stiffness greater than about 3600 lb_{f} in² averaged over the length of the second section.

38. The method of claim 37, wherein the second section is less than about 8 inches in length.

39. The method of claim 36, wherein the bending stiffness of the second section is greater than about 4300 lb_{f} in² averaged over the length of the second section.

40. The method of claim 36, wherein the bending stiffness of the second section is greater than about 5600 lb_{f} in² averaged over the length of the second section.

41. The method of claim 38, wherein the cue stick has a specific section modulus less than about 10000 lb_{f} in³/g averaged over the second section.

42. A cue stick, comprising:
a shaft comprising a node, the composition of the shaft at or proximal to the node being different from the composition of the shaft over the remainder of the shaft in order to affect the performance of the cue.

43. The cue stick of claim 42, wherein the composition of the shaft at or near the node includes a material to modify the stiffness of the cue at or proximal to the node relative to the stiffness over the remainder of the shaft.

44. The cue stick of claim 43, wherein the material increases the stiffness of the cue at or proximal to the node relative to the remainder of the shaft.

45. The cue stick of claim 43, wherein the material decreases the stiffness of the cue at or proximal to the node relative to the remainder of the shaft.

46. The cue stick of claim 43, wherein the material comprises a light-weight material.

47. The cue stick of claim 43, wherein the material comprises at least one of Boron, glass, plastic and Kevlar.

48. The cue stick of claim 43, wherein the material comprises Boron.

49. The cue stick of claim 43, wherein the cue stick is comprised of a composite material, and the material to modify the stiffness of the cue is incorporated in the composite material.

50. The cue stick of claim 42, wherein the material at or proximal to the node is different from the composition of the shaft over the remainder of the shaft in order to affect the vibration dampening of the cue stick.

51. The cue stick of claim 42, wherein the material at or proximal to the node is different from the composition of the shaft over the remainder of the shaft in order to affect the acoustic attenuation of the cue stick.

52. The cue stick of claim 42, wherein the shaft comprises a plurality of nodes along the length of the shaft, and the composition of the shaft at or proximal to each node is different from the composition of the shaft over the remainder of the shaft.

53. A method of manufacturing a cue stick, comprising:
providing a shaft comprising a node;
modifying the composition of the shaft at or proximal to the node relative to the composition of the shaft over the remainder of the shaft in order to affect the performance of the cue.

54. The method of claim 53, wherein modifying the composition of the shaft at or proximal to the node point comprises incorporating a material that changes the stiffness of the cue at or proximal to the node point relative to the remainder of the shaft.

55. The method of claim 54, wherein the material that changes the stiffness is a light-weight material comprising at least one of Boron, plastic, glass and Kevlar.

56. The method of claim 55, wherein the material comprises Boron.
